(19) United States
(12) Patent Application Publication
(10) Pub. No.: US 2010/0150519 A1
(43) Pub. Date: Jun. 17, 2010

(54) VIDEO REPRODUCING APPARATUS, A VIDEO SYSTEM, AND A REPRODUCTION SPEED CONVERTING METHOD OF VIDEO

(75) Inventors: Kenta TAKANOHASHI, Chigasaki (JP); Yoshiaki MIZUHASHI, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Consumer Electronics Co., Ltd.

(21) Appl. No.: 12/624,435

(22) Filed: Nov. 24, 2009

(30) Foreign Application Priority Data
Dec. 12, 2008 (JP) 2008-316394

(51) Int. Cl. H04N 5/93; H04N 5/91; H04N 7/26

(52) U.S. Cl. 386/52; 386/68; 386/95; 386/109; 386/E09.001; 386/E05.003; 715/719

(57) ABSTRACT

For smoothing motion of an video during time of a special reproduction, in a video reproducing apparatus, for outputting an input video signal while holding it temporarily therein, comprises a buffering portion (100), and a video speed converter portion (101), for producing an interpolation frame responding to motion of video with using a plural number of video frames, which are outputted from the buffering portion, and thereby outputting a video signal, a reproduction speed of which is converted by combining the interpolation frame and the video frame from the buffering portion. And, a time distance of video frames of the video signal, which is outputted from the buffering portion, as well as, a producing process and a combining process, for producing an interpolation frame within the video speed converter portion, are controlled depending on a control signal indicating a reproduction speed.

### BACKGROUND OF THE INVENTION

The present invention relates to a technology for converting a reproduction speed of video, so as to achieve a special reproduction (i.e., a quick view or a slow view).

Conventionally, on a video reproducing apparatus, such as, a DVD player, etc., is mounted a special reproducing function, such as, a quick-view reproduction for the purpose of confirming video quickly, or a slow-view reproduction for outputting an audio, which an aged person or a hearing-impaired person can listen, easily, etc.

The video during the special reproduction is a video, which is produced by simply omitting or repeating frames of an input video, and it sometimes brings about a case where a feeling that something is wrong, i.e., rattling in the motion thereof. As a technology for dissolving such the feeling of rattling in the motion, the technology disclosed in the following Patent Document 1 is already known.

[Patent Document 1] Japanese Patent Laying-Open No. Hei 7-222106 (1995)

### BRIEF SUMMARY OF THE INVENTION

Although the Patent Document 1 mentioned above discloses therein the structures for smoothing the video during the quick-view reproduction, however no consideration was paid upon the feeling of rattling in the motion during the slow-view reproduction. Also, no consideration was paid upon synchronization between the video and audio, which are produced through the special reproduction.

The present invention is accomplished by taking the drawback mentioned above into the consideration thereof, and an object thereof is to provide a technology for enabling to obtain a video without such wrong feeling even during the special reproduction. Also, according to the present invention, there is provided a technology for obtaining the synchronization to be preferable between the video and the audio, which are produced through the special reproduction.

According to the present invention, it is characterized in that a time distance between video frames in an input video signal is controlled depending on a reproduction speed designated, and also the video frames, the time distance of which is controlled, and an interpolation frame, which is obtained from a plural number of video frames and compensated in the motion thereof (i.e., an interpolation frame, which is produced with using a motion vector), are combined, so as to convert the reproduction speed.

Also, according to the present invention, it is characterized in that an audio signal is divided, time-wisely, and also the reproduction speed of the audio signal is converted by copying or deleting the audio signal, which is divided time wisely, at timing depending on that reproduction speed designated, periodically.

According to the present invention, since the interpolation frame, which is obtained from the video frames and is compensated in the motion thereof, is combined with the video frames, the time distance of which is controlled depending on the reproduction speed, it is possible to reproduce a video having smooth motion, corresponding to both, a quick-view reproduction and a slow-view reproduction. It is also possible to bring an audio of the video, the reproduction speed of which is converted, to be in synchronism therewith.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing a first embodiment of a video reproducing apparatus, according to the present invention;

FIG. 2 is a view for showing an example of video processing when conducting a slow-view reproduction, according to the first embodiment;

FIG. 3 is a view for showing an example of video processing when conducting a quick-view reproduction, according to the first embodiment;

FIG. 4 is a view for showing an example of video processing when conducting a slow-view reproduction, according to the first embodiment;

FIG. 5 is a view for showing an example of video processing when conducting a quick-view reproduction, according to the first embodiment;

FIG. 6 is a block diagram for showing a second embodiment of a video reproducing apparatus, according to the present invention;

FIG. 7 is a block diagram for showing a third embodiment of a video reproducing apparatus, according to the present invention;

FIG. 8 is a block diagram for showing a fourth embodiment of a video reproducing apparatus, according to the present invention;

FIG. 9 is a block diagram for showing a fifth embodiment of a video reproducing apparatus, according to the present invention;

FIG. 10 is a block diagram for showing a sixth embodiment of a video reproducing apparatus, according to the present invention;

FIG. 11 is a block diagram for showing a seventh embodiment of a video reproducing apparatus, according to the present invention;

FIG. 12 is a view for showing an example of display superposing a speed-converted video and a caption, according to the seventh embodiment;

FIG. 13 is a block diagram for showing an eighth embodiment of a video reproducing apparatus, according to the present invention;

FIG. 14 is a block diagram for showing a ninth embodiment of a video reproducing apparatus, according to the present invention; and

FIG. 15 is a view for showing an example of detection of a motion vector and producing of an interpolation frame.

### DETAILED DESCRIPTION OF THE PREFERRED EMBODIMENTS

Hereinafter, preferable embodiments for implementing the present invention will be fully explained, by referring to the attached drawings.

### Embodiment 1

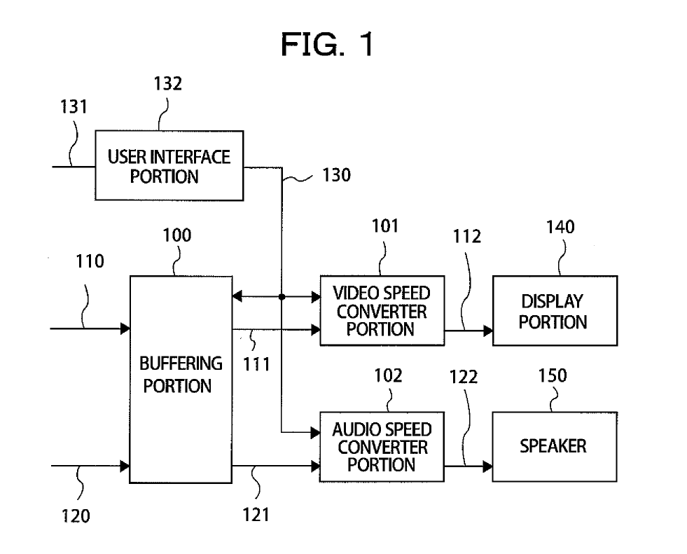

First of all, explanation will be given on a first embodiment of the present invention, by referring to FIGS. 1 to 5. FIG. 1 shows a circuit block diagram of the first embodiment of the video reproducing apparatus, according to the present invention, wherein as is shown in the figure, a buffering portion 100, a video speed converter portion 101, an audio speed converter portion 102, a user interface portion 132, a display portion 140 and a speaker 150. The present embodiment is a television receiver, having the display portion 140 and the speaker 150, and a built-in recording medium, such as, a HDD (Hard Disc Drive), etc., for example. However, it is needless to say that the present embodiment is also applicable into a HDD recorder or a DVD recorder/player, having no such the display portion 140 and the speaker 150.

Hereinafter, explanation will be give about the operation and function of each element, in details thereof.

The user interface portion 132 outputs a control signal 130 indicating that reproduction speed in accordance with a reproduction speed indication or instruction 131 from a user. For example, if the user interface portion 132 is a remote control transmitter, then the reproduction speed instruction 131 is press-down information of “quick” and “slow” buttons, which are attached on the remote controller. The user interface portion 132 memorizes the present reproduction speed therein, and it outputs the control signal 130 for indicating the reproduction speed, with increasing/reducing the reproduction speed by ±10% depending on a reproduction speed instruction 500. Thus, if the “quick” button is pressed down during when the reproduction speed just before is 80%, then the control signal 130 is outputted for changing the reproduction speed down to 90%. In the similar manner, if the “slow” button is pressed down during when the reproduction speed just before is 80%, then the control signal 130 is outputted for changing the reproduction speed down to 70%. However, herein, assuming that 100% is a normal speed, it is a slow-view reproduction when lower than that, and a quick-view reproduction when higher than that.

The user interface portion 132 may be in any kind of configuration, as far as it has an input function for accepting the reproduction speed from the user. Other than the above-mentioned, the user may input the reproduction speed instruction 131, with using numeric keys attached on the remote controller, for example.

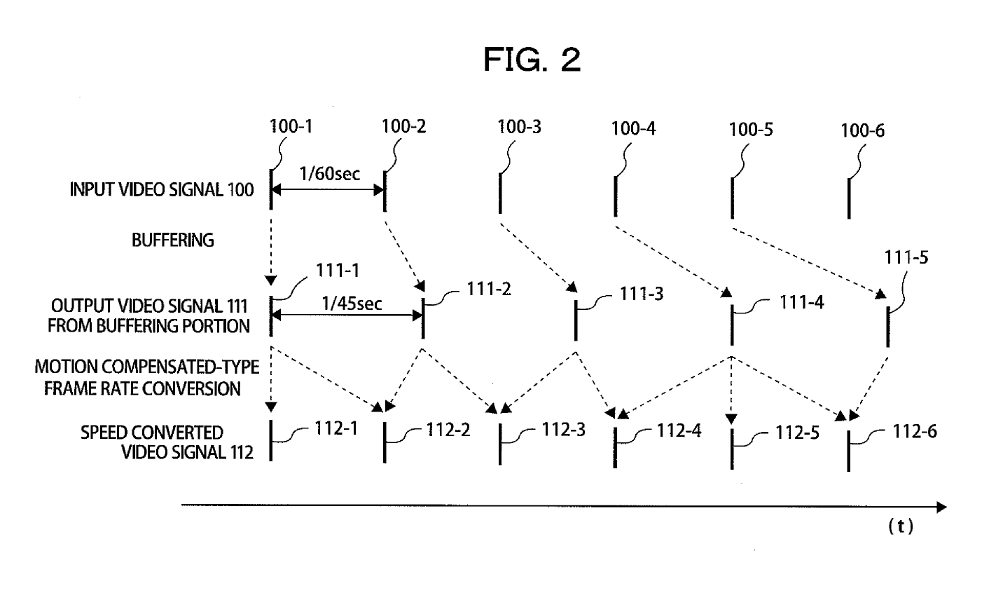

The buffering portion 100 stores an input video signal 110 and an input audio signal 120, temporarily, and outputs them. This buffering portion 100 has a function of conducting a time-wise relocation of the input video signal 110 and the input audio signal 120, depending on the control signal 130 indicating the reproduction speed from the user interface portion 132 mentioned above. This time-wise relocation is conducted, as is shown in FIG. 2, by controlling a mutual time distance between a plural number of video frames in the input video signal 110, in case of the video signal.

FIG. 2 shows a time relationship of the buffering portion 100, which is relocated in time (i.e., the time distance is controlled between the video frames), with respect to the output video signal 111, when the reproduction speed is 75% (slow-view reduction). Herein, video frame lines of the input video signal are shown with attaching reference numerals 100-1 through 100-6, and the video frame lines of the output video signal from the buffering portion 100 with attaching reference numerals 111-1 through 111-5, respectively.

In case where the control signal 130 indicates the reproduction speed of 75%, the buffering portion 100 outputs the video signals, sequentially, by controlling a period to be enlarged to 1/45 second, i.e., the distance of 75% thereof, as is shown by the frames 111-1 through 111-5 in FIG. 2, when a frame rate of the input video signal 110 is 60 Hz, i.e., the time distance between the video frames (i.e., period) is 1/60 second.

In this manner, the video signal 111, which is relocated time-wisely within the buffering portion 100 mentioned above, is outputted to the video speed converter portion 101. However, since this buffering portion 100, according to the present embodiment, is able to bring the time distance between the video frames of that input video signal to be different from the time distance between the video frames of the output video signal different, then preferably, it may be a memory device (for example, a HDD, etc.) having such a large capacity that it can stores therein the video signals for several minutes or more, or for one (1) piece of a program (for example, 30 minutes to 2 hours) or more, if possible.

The video speed converter portion 101 stores therein time-wisely continuous two (2) pieces of video frames from the video signal 111, which is outputted from the buffering portion 100 and time-wisely relocated, and it detects the motion vector indicating the motion of the vide from those. With using this motion vector detected, an interpolation frame is produced from those two (2) video frames, through a linear interpolating process and/or a weighted averaging process, etc., for example. And, the video frames, which are time-wisely relocated, and the interpolation frames are combined, in such a manner that the video frames and the interpolation frames are disposed at the time-wise positions depending on the reduction time, which is indicated by the control signal 130, and with doing this, a frame rate conversion is done upon the output video signal 111 from the buffering portion 100. With this, conversion of the reproduction speed is done, and a speed converted video signal 112 is produced.

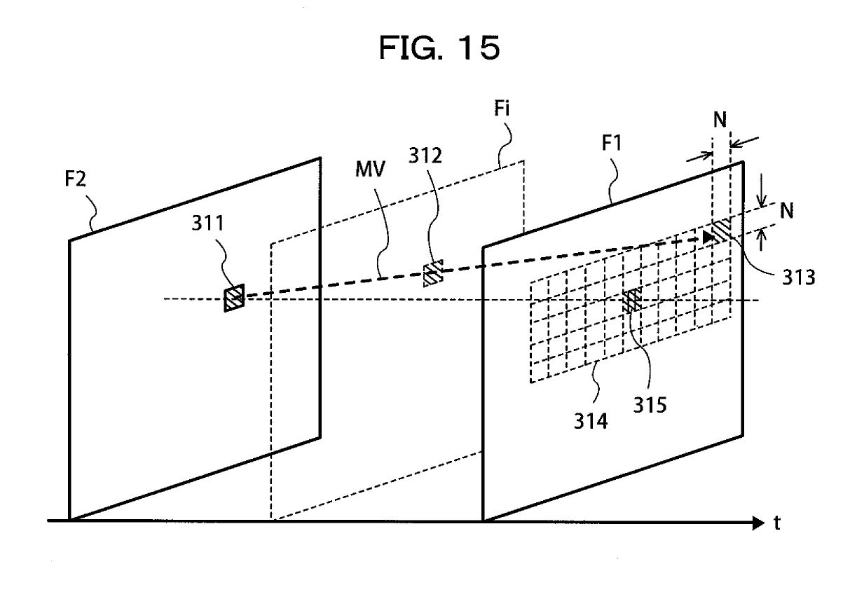

Herein, explanation will be made on an example of detection of the motion vector and production of the interpolation frame within the video speed converter portion 101, by referring to FIG. 15. In the present embodiment, as a detecting method of the motion vector may be applied a block matching method or an inclination method, or a phase-limit correlation method, etc., which are already known conventionally. Herein, it is assumed that the block matching method is applied. Also, in FIG. 15, it is assumed that, between two (2) pieces of video frames, the video frame time-wisely appearing in the past is a previous frame “F2”, and that the frame appearing at the present time is a present frame “F1”, respectively.

FIG. 15 shows a manner of detecting the motion vector when an interpolation frame “Fi” is inserted between the present frame “F1” and the previous frame “F2” time-wisely continuing thereto. It is assumed that the motion vector “MV” indicates the motion of a certain target block 311 on the previous frame “F2” to which block on the present frame “F1”. Those blocks are assumed to have a pixel number, N×N pixels, therein. “N” is an integer, and a numeral may be selected as it, for example, 2, 4, 8, 16, etc.

First of all, upon basis of a block 315 spatially locating at the same position to that of the target block 311 on the previous frame “F2” (i.e., locating at the point-symmetrical position), a search region 314 of a predetermined bock number is determined or set up on the present frame “F1”. Herein, it is assumed that the block number of the search region 314 is defined by 11 pieces in the horizontal direction and 5 pieces in the vertical direction, i.e., 55 block in total, and within the search region 314, coordinates of the position of the standard block 315 are (0,0). Next, a difference value is calculated between each block of the setup search region 314 and the target block 311 on the previous frame “F2”, respectively. Following to this, as a result of this calculation, a block within the search region 314, being smallest in the difference value, is determined to be a block at moving destination of the target block 311, which was on the previous frame “F2”, on the present frame “F1”. A straight line connecting between this block at the moving destination and the target block 311 on the previous frame “F2” is the motion vector, which is shown by broken line in FIG. 15. In this FIG. 15, if assuming that the block 313 is the block, which is smallest in the difference, for example, then it can be said that the target block 311 on the previous frame “F2” has moved to the block 313 locating at the coordinates (5,2) on the present frame “F1”, in accordance with the direction of the motion vector “MV” shown by the broken line.

The processes starting from the determining the search region 314 up to the obtaining information of the motion vector “MV” are conducted upon all blocks of the previous frame “F2”, and then the motion vector “MV” is detected and determined for each of all blocks. However, though the motion vector is detected with a unit of block, which is constructed with a plural number of pieces, in the present embodiment, but the motion vector may be detected for each pixel in the manner or method similar to the processes mentioned above.

Herein, it is considered that one (1) piece of the interpolation frame “Fi” is inserted between the present frame “F1” and the previous frame “F2”, as is shown in FIG. 15. In this instance, it can be assumed that the target block 311 moves to the block 313 of the present frame “F1”, passing through the block 312 within the interpolation frame “Fi” (hereinafter, it will be called, an “interpolation block”). Accordingly, the pixel data of the interpolation block 312 can be obtained, through a process of calculating an intermediate value or an averaged value of the pixel data of the target block 311 on the previous frame “F2” and the pixel data of the block 313, which is indicated by the motion vector “MV”, for example, through a filtering process of a linear interpolating process and/or a weighted averaging process, etc. With conducting this calculation (i.e., the filtering process) upon all blocks of the previous frame “F2”, the pixel data can be obtained of all the interpolation blocks of the interpolation frame “Fi”, and an interpolation frame of motion compensation type can be produced.

A manner in which the speed converted video signal 112 is produced by producing the interpolation signal, from the output video signal 111 of the buffering portion 100, which is time-wisely relocated, is shown in FIG. 2.

As is shown in the figure, the video frames included in the (time-wisely relocated) output video signal 111 from the buffering portion 100, for example, from the video frames 111-1 and 111-2, the interpolation frame 112-2 is produced with the method, which is shown in FIG. 15, for example. In the similar manner, the interpolation frames 112-3, 112-4 and 112-5 are produced from two (2) pieces of the video frames of the output video signal 111, which are neighboring to each other in front and back. However, as the frames 112-1 and 112-5 are used the same ones to the video frames 111-1 and 111-4 of the output video signal 111 (i.e., the video frames 100-1 and 100-4 of the input video signal), respectively. Namely, in case when the reproduction speed is 75%, a process is repeated, periodically, of replacing two (2) (for example, the frames 111-2 and 111-3) of three (3) pieces of the video frames (for example, the frames 111-1 through 111-3), which are expanded to 1/45 second in the period thereof, by three (3) pieces of the interpolation frames (for example, frames 110-2 through 111-4). In this manner, the interpolation frame and the video frame, the time distance of which is controlled, are combined with, and converted in the frame rate thereof, from 45 Hz to 60 Hz; therefore, the speed converted video signal 112 is produced with lowering the reproduction speed thereof down to 76%.

However, the filtering process for producing the interpolation frame mentioned above is controlled depending on the time position of that interpolation frame. For example, it is assumed that an interpolation frame 1112-4 has a ratio 1:3 in the time distance between it and the video frame 111-3 and the time distance between it and the video frame 111-4. In this case, the block including that interpolation frame 112-4 therein can be obtained by multiplying a coefficient of ¼ on the block of the video frame 111-3, which is indicated by the motion vector “MV” passing through that block, further by multiplying a coefficient ¾ on the block of the video frame 111-4, and adding them to each other.

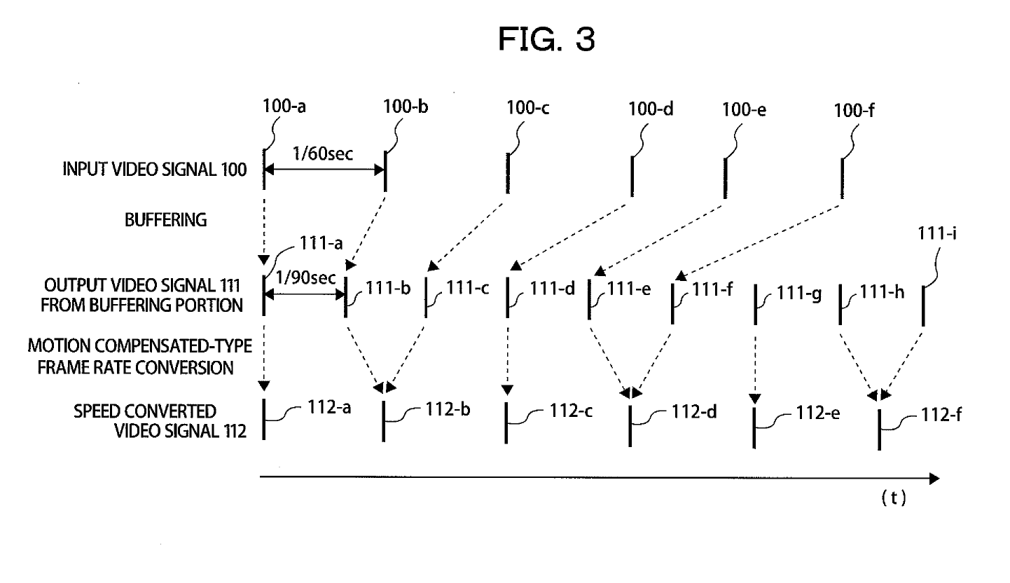

Next, explanation will be made on the case of the quick-view reproduction, by referring to FIG. 3. This FIG. 3 shows a manner of producing the speed converted video signal 112, by producing the interpolation frame the time relationship between the input video signal 100 of the reproduction speed 150% (i.e., the quick-view reproduction) and the output video signal 111 from the buffering portion 100, which is time-wisely relocated, and the output video signal 111 from the quick-view reproduction) and the output video signal 111 from the buffering portion 100, which is time-wisely relocated. Herein, the video frame lines of the input video signal 110 are shown by reference numerals 100-a through 100-f, and the video frame lines of the output video signal 111 of the buffering portion 100 are shown by reference numerals 111-a through 111-i, respectively. Also, the frame lines of the speed converted video signal are shown by reference numerals 112-a through 112-f.

When the control signal 130 indicates the reproduction speed of 150%, the buffering portion 100 outputs the video signal, sequentially, by controlling the period to be shorten down to 1/90 second, at a distance of 1.5 times thereof, as is shown by the frames 111-1 through 111-5 in FIG. 2, if assuming that a frame rate of the input video signal 110 is 60 Hz, i.e., the time distance (i.e., the period) between the video frames is 1/60 second.

The video speed converter portion 101 produces the speed converted video signal 112 having 60 Hz in the frame rate through a frame rate conversion of motion compensation type, about the video signal, the video frame distance of which is converted to the period of 1/90 second by the buffering portion 100, as was mentioned above. The frame rate conversion of such motion compensation-type is processing for, herein, as is shown in FIG. 3, producing an interpolation frame 112-b from two (2) pieces of the video frames (for example, 111-b and 111-c), among three pieces of video frames (for example, 111-a through 111-c) of the output video signal 111 from the buffering portion 100, through the method shown in FIG. 15, and replacing this interpolation frame 112-b by said two (2) pieces of video frames 111-b and 111-c, and this is repeated periodically (by a period of three (3) frames). Therefore, as the frames 112-a, 112-c and 111-e of the speed-converted video signal 112 are used the same ones to the video frames 111-a, 111-d and 111-g of the output video signal 111, respectively. In this manner, the interpolation frames and the video frames, which are controlled in the time distances thereof, are combined with, and are converted in the frame rate thereof from 90 Hz to 60 Hz, and thereby producing the speed-converted video signal 112. Herein, since the interpolation frames 112-b, 112-d and 111-f are in a ratio of 1:1 in the time distance thereof, respectively, with respect to the two (2) pieces of video frames of the output video signals 112 neighboring with each other in front and back, therefore from those two (2) pieces of neighboring frames, a filtering process is conducted with using a coefficient ½.

Such a process of combining the video frames of the video signal, the time distance of which is controlled, and the interpolation frames, an also such a producing process of the interpolation frames including the coefficient to be used in the filtering process, as was mentioned above, are controlled depending upon the reproduction speed, which is indicted by the control signal 130. It is so controlled that, in case where the reproduction speed is 75% as was mentioned above, the process is repeated, periodically, of replacing two (2) pieces among the three (3) pieces of video frames, which are enlarged to 1/45 second in the period, by three (3) pieces of interpolation frames, but in case where the reproduction speed is 80%, the process is repeated, periodically, of replacing three (3) pieces among the four (4) pieces of video frames, which are enlarged to 1/48 second in the period, by four (4) pieces of the interpolation frames. In case where the reproduction speed is 120%, it is so controlled that the process is repeated, periodically, of replacing five (5) pieces among the six (6) pieces of video frames, which are shorten to 1/72 second in the period, by four (4) pieces of the interpolation frames. And, the coefficient to be used in the filtering process of this instance is also changed, appropriately, depending on the timewisely positional relationship between the video frame line, the time distance of which is controlled, and the interpolation frames.

The speed-converted video signal 112, the reproduction speed of which is converted within the video speed converter portion 101, as was mentioned above, is supplied to the display portion 140, being built up with a liquid crystal panel or a POP, etc., for example, so that the video, which is converted to the reproduction speed indicated by the control signal 130 is reproduced and displayed thereon.

On the other hand, also with the input audio signal 120, the time distance thereof is controlled within the buffering portion 100 depending on the reproduction speed, which is indicated by the control signal 130, in the similar manner to the input video signal 110. For example, in case where the control signal 130 indicates the reproduction speed 75% (i.e., the slow-view reproduction), the buffering portion 100 outputs audio signals, sequentially, at a distance of 0.75 time thereof, at 33 kHz, if the sampling rate of the input audio signal is 44 kHz, for example.

The audio speed converter portion 102 caries out the speed conversion upon the audio signals 121, which are timewisely relocated within the buffering portion 100, so as to bring the speed to be equal to that of the video signal, which is converted in the speed thereof, in accordance with the reproduction speed indicated by the control signal 130, and outputs a speed-converted audio signal 122.

Various kinds of algorithms are proposed for conversion of the audio speed; however, within the present embodiment, it is assumed to use an algorithm therein, i.e., dividing the audio signal divided into a certain minimum time unit, timewisely, and conducting the speed conversion upon the audio signal by the unit divided, through coping or deleting thereof. However, the present invention should not be limited only to this algorithm.

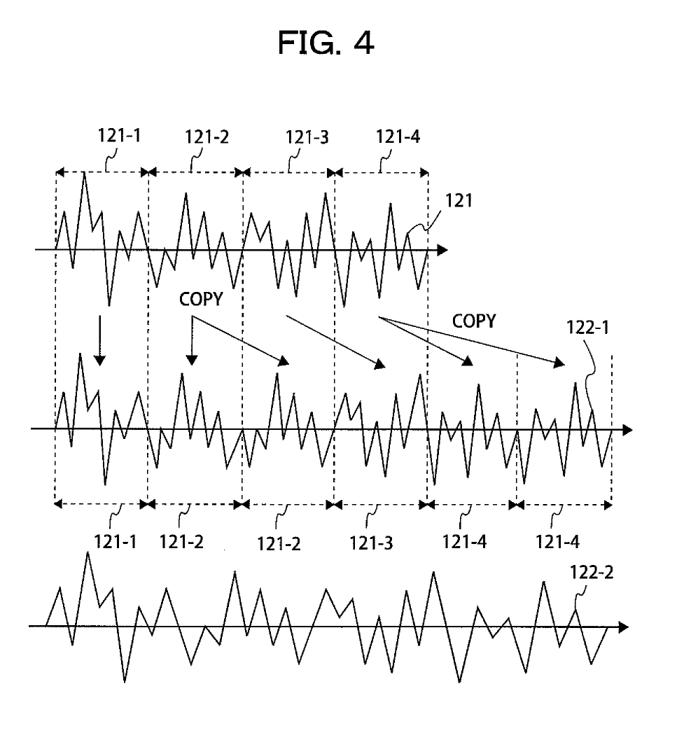

FIG. 4 is for showing the manner of conversation of the reproduction speed of the audio signals with applying the algorithm mentioned above therein, and it shows the manner, in particular, when slowing down the reproduction speed (i.e., the slow-view reproduction). First of all, the input audio signal 121 is divided into a predetermined time unit, and thereby obtaining the divided audio signals 121-1, 121-2, 121-3 and 121-4. And, copying is conducted upon those divided audio signals at a period according to the reproduction speed indicated by the control signal 130. When wishing to convert the input audio signal 120 down to the speed of 75%, coping is conducted at every one (1) predetermined time unit, so that the respective divided audio signals 121-2 and 121-4 appears two (2) times, continuously. Accordingly, the speed-converted audio signal 122-1 appears, as is shown in FIG. 4, i.e., in the order of the divided audio signals 121-1, 121-2, 121-2, 121-3, 121-4, 121-4 . . .

This algorithm has an advantage that a pitch of sound does not change, comparing to the audio 122-2, which is converted in the speed thereof in accordance with the method of compulsively reproducing the input audio 121 by a frequency differing from the sampling rate.

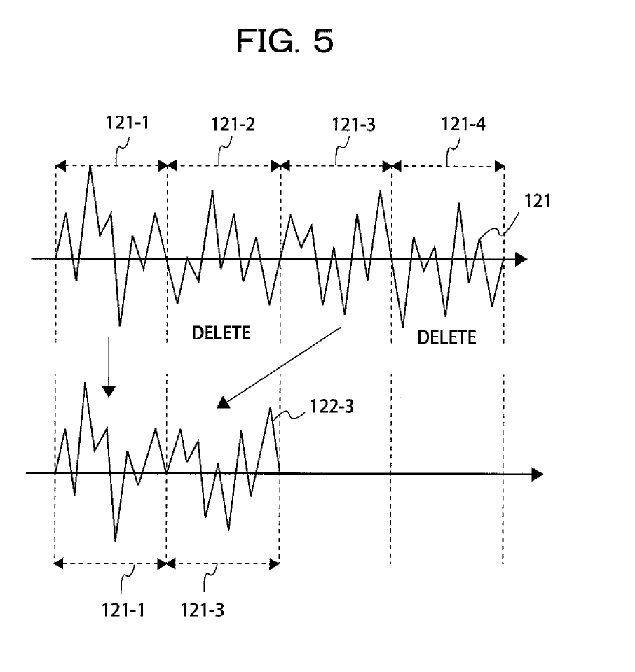

FIG. 5 shows a manner of the conversion in case of fastening the reproduction speed (i.e., the quick-view reproduction). In this example, by deleting the signals 121-2 and 121-4 among the divided audio signals 121-1 through 121-4, which are obtained by dividing the input audio signal 121 timewisely, the audio signal 122-3 is produced, which are converted in the speed thereof up to the speed 200%. Accordingly, the speed-converted audio signal 122-1 appears, as is shown in FIG. 5, i.e., in the order of the divided audio signals 121-1, 121-3 . . .

The speed-converted video signal 112, the reproduction speed of which is converted within the audio speed converter portion 102 is supplied to the speaker, for example, and the video and the audio, which are converted into the reproduction speed indicated by the control signal 130, are reproduced and outputted, in synchronism with each other.

With such structures as was mentioned above, since the speeds of the video and audio can be changed depending on the speed information indicted by the control signal, which is given from an outside, therefore it is possible to reproduce the video and audio at the reproduction speed, which the user wishes to have.

Also, since the interpolation process is done between the frames or the fields depending on the motion of the video, within the video speed converter portion 101, it is possible to view the video, which is converted into an arbitrary speed, smoothly and with suppressing to give a feeling that something is wrong. Also, in case where the speed conversion rate is small, it is possible not to give the wrong feeling of the speed conversion to a person who is watching the video.

Further, since the audio speed converter portion 102 outputs the audio, the speed conversion thereof being done with copying or deleting the audio, which is divided timewisely, therefore it is possible to listen the audio, which is converted into an arbitrary speed, without changing the pitch of sound, smoothly and with suppressing to give a feeling that something is wrong. Also, in case where the speed conversion rate is small, it is possible not to give the wrong feeling of the speed conversion to a person who is hearing the audio. Further, also since the speed conversion of this audio is carried out responding to the speed conversion of the video, according to the control signal 130, therefore it is possible to bring the video and the audio to be in synchronism with each other even when the reproduction speed is changed arbitrarily.

### Embodiment 2

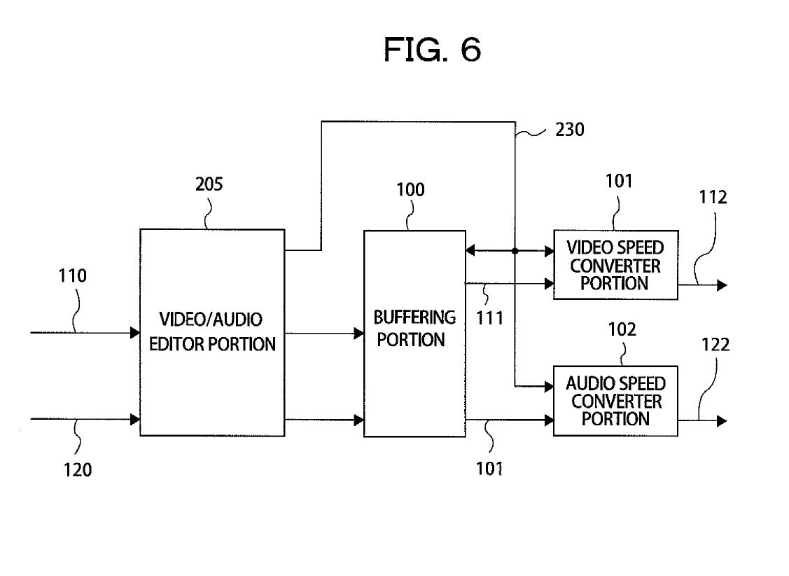

Explanation will be made on a second embodiment according to the present invention, by referring to FIG. 6.

The embodiment 2 has the structure of adding a video/audio editor portion 205, which is able to convert the reproduction speed depending on edition of the video and audio, in the place of the user interface portion 132, in the circuit block diagram of the embodiment 1 shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 6 is omitted illustration of the display portion 140 ad the speaker 150. Also, hereinafter, the buffering portion 100, the video speed converter portion 101 and the audio speed converter portion 102 may be called, sometimes “a speed converter portion”, collectively.

The video/audio editor portion 205 inserts the video signal and/or the audio signal of an arbitrary length to the input video signal 110 and/or the audio signal 120, responding to an instruction of the user, or alternately deletes the video signal and/or the audio signal of an arbitrary length from the input video signal 110 and/or the audio signal 120, and transmits it/them into the buffering portion 100. Also, it outputs a control signal 230, indicating a quick-view instruction (i.e., the reproduction speed higher than 100%) when inserting the video signal and/or the audio signal, or alternately, a slow-view instruction (i.e., the reproduction speed lower than 100%) when deleting the video signal and/or the audio signal.

Also, the video/audio editor portion 205 may analyze the input video signal 110 and/or the audio signal 120, so that it operates to delete a commercial message portion, automatically, from television broadcast signals received, or contents reproduced by external equipment, for example. In this instance, because the commercial message portion is deleted, the video/audio editor portion 205 transmits the control signal 230 indicative of the slow-view instruction, as the reproduction speed information. At this time, the reproduction speed is determined or set to such a slow speed that does not give the wrong feeling when the user is viewing and/or listening to. It may be set to a slow-view from about 90% to 95%, for example.

Although various kinds of algorithms are proposed for detecting the commercial message, but in the present embodiment, the kind of the algorithm should not be limited to. For example, there may be applied an algorithm of detecting CM due to the difference between a monaural broadcasting (main edition) and a stereo broadcasting (CM), or an already-known algorithm of detecting CM through detecting presence of a caption, etc.

With the structures mentioned above, according to the present embodiment, even if deleting or adding the video, since the speed converter portion changes the reproduction speed also by taking the information of that deleted or added video into the consideration thereof, it is possible to maintain a total audience time if deleting or adding the video thereto.

Also, in case where the video/audio editor portion 205 is constructed to delete the commercial message portion, it is possible to view/listen the broadcast wave, from which the CM portion is removed, in real-time, by delaying the reproduction speed while deleting the commercial message portion within the video/audio editor portion 205. Thus, while continuing the slow-view reduction of about 90% to 95% comparing to the normal, if buffering can be made upon the main edition video and the audio for the CM time, until when the CM comes, it is possible to output the video, from which the CM is cut out in real-time. For example, if continuing the slow-view reproduction of 90% for 10 minutes, since a discrepancy of one (1) minute is generated comparing to the real time, then it is possible to cut off the CM of one (1) minute.

### Embodiment 3

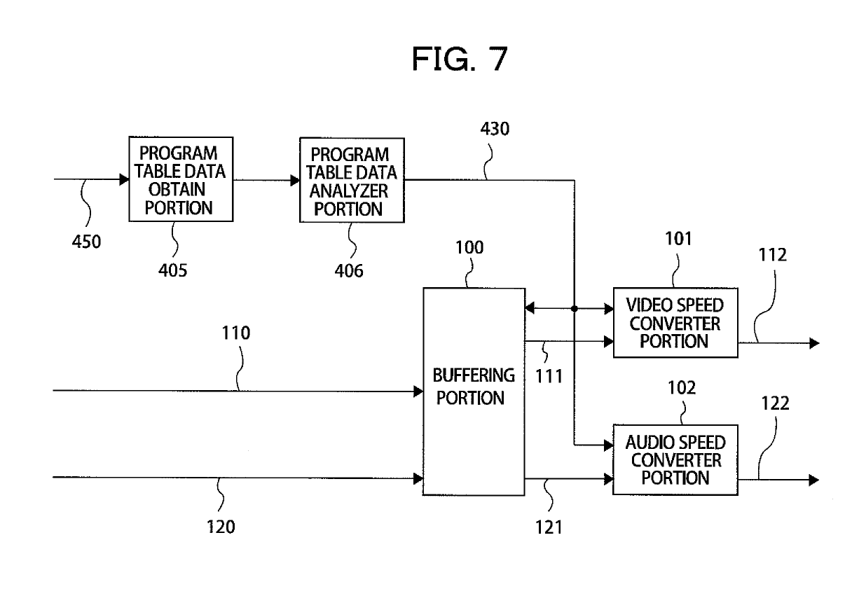

Next, explanation will be made on a third embodiment, by referring to FIG. 7.

This third embodiment has the structure of adding a program listing data obtain portion 405 and a program listing data analyzer portion 406, in the place of the user interface 132, within the circuit block diagram of the first embodiment shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 7 is omitted illustration of the display portion 140 ad the speaker 150.

The program listing data obtain portion 405 obtains the program listing (EPG: Electronic Program Guide) data 450 through the Internet or the broadcast signal, and sends that EPG data to the program listing data analyzer portion 406.

The program listing data analyzer portion 406 receives the EPG data from the program listing data obtain portion 405, so as to obtain the program information, relating to the program under reproduction at the present, from the EPG data, and outputs a control signal 430 by determining the reproduction speed upon basis of that program information.

In this instance, within the program listing data analyzer portion 406, the reproduction speed is determined by genre or category information of the program, for example. The program listing data analyzer portion 406, storing the information, such as, a normal speed reduction when a music program, 120% quick-view reproduction when a news program, etc., for example, in advance, determines the reproduction speed corresponding to the program, and outputs the control signal 430 indicating that reproduction speed to the speed converter portion. If the genre or category information of the program is included in the EPG data, it may be utilized, or a string of characters may be searched for presenting a word, from which the genre or category of the program can be discriminated. For example, with searching a word, such as, “music” or “news”, etc., for example, from the word strings within the EPG data, and categorizes can be made, such as, the music program or the news program.

With such the structures as was mentioned above, it is possible to convert the reproduction speed corresponding to the program contents, by analyzing the EPG data, which is obtained within the program listing data obtain portion 405, within the program listing data analyzer portion 406, and by classifying the programs into the followings; i.e., a program, upon which high-speed reproduction can be made (for example, a sports program, etc.), a program, upon which a low-speed reproduction should be made for easy listening (for example, a news program, etc.), and a program, the speed of which should not be changed (for example, a music program, etc.), it is possible to conduct the conversion of the reproduction speed corresponding to the program contents.

### Embodiment 4

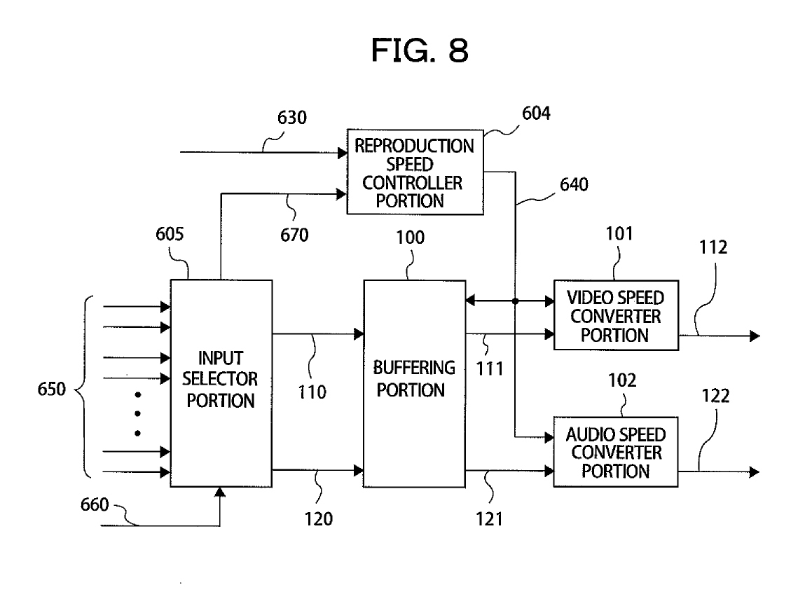

Next, explanation will be made on a fourth embodiment, by referring to FIG. 8.

This fourth embodiment has the structure of adding an input selector portion 605 and a reproduction speed controller portion 604, in the place of the user interface 132, within the circuit block diagram of the first embodiment shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 8 is omitted illustration of the display portion 140 ad the speaker 150.

The input selector portion 605, inputting a plural number of video and audio signals 650 and a selector signal 660 therein, selects one (1) of them, from those video and audio signals 650, depending on the selector signal 660, and thereby to send it to the buffering portion 600, as the input video signal 110 and the input audio signal 120.

For example, it is assumed that the video and audio signals, which are reproduced from the recoding equipment (hereinafter, it is called, “a recoding signal(s)”), and the video and audio signals of television broadcast (hereinafter, it is called, “a broadcast signal(s)”) are included within the plural number of video and audio signals 650. In this instance, within the input selector portion 605, yes/no (or, necessity/unnecessity) of the reproduction speed conversion is determined, in advance, depending on the sorts or kinds of the input signals; like, the reproduction speed conversion will be conducted upon the recording signal(s), while the reproduction speed conversion will not conducted upon the broadcast signal(s), etc., for example.

To the selector signal 660 is provided an output, depending on an instruction by the user, for example. The input selector portion 605 selects the recording signals from the plural number of input video and audio signals 650, when inputting the selector signal 660 for selecting the video and audio signals of the television broadcast therein, due to the instruction by the user, and outputs them to the buffering portion 600 as the input video signal 110 and the input audio signal 120. At the same time of this selection, it also transmits a reproduction speed change signal 670, indicating that change of the reproduction speed is allowable, to the reproduction speed controller portion 604.

On the other hand, when the selector signal 660 for selecting the video and audio signals of the television broadcast is inputted therein, the input selector portion 605 selects the broadcast signals from the plural number of video and audio signals, and outputs them to the buffering portion 600 as the input video signal 110 and the input audio signal 120. At the same time of this selection, it also transmits a reproduction speed change signal 670, indicating that change of the reproduction speed is not allowable, to the reproduction speed controller portion 604.

The reproduction speed controller portion 604 outputs a change control signal 640, by changing the control signal 630 indicating the reproduction speed, which is determined by the user, for example, upon basis of the reproduction speed change signal 670, which is outputted from the input selector portion 605. For example, in case where the reproduction speed change signal 670 from the input selector portion 605 indicates that the reproduction speed is allowable to be changed, it transmits the control signal 630 as it is, to the speed converter portion, as the change control signal 640. On the other hand, in case where the reproduction speed change signal 670 from the input selector portion 605 indicates that the reproduction speed is not allowable or permissible to be altered, it transmits the control signal 630, with changing it to 100% (i.e., no speed conversion is made), to the speed converter portion, as the change control signal 640.

With such the structures as was mentioned above, according to the present embodiment, since the input selector portion 605 determines yes/no (or, necessity/unnecessity) of the reproduction speed conversion, depending on the selection of the plural number of video and audio signals, then the following control can be conducted, automatically, i.e., the reproduction speed is converted in accordance with the instruction by the user, for example, when selection is made on the video and audio signals, which are recorded on a recorder, or no speed conversion is made when selection is made on the video and audio signals of the television broadcast received.

### Embodiment 5

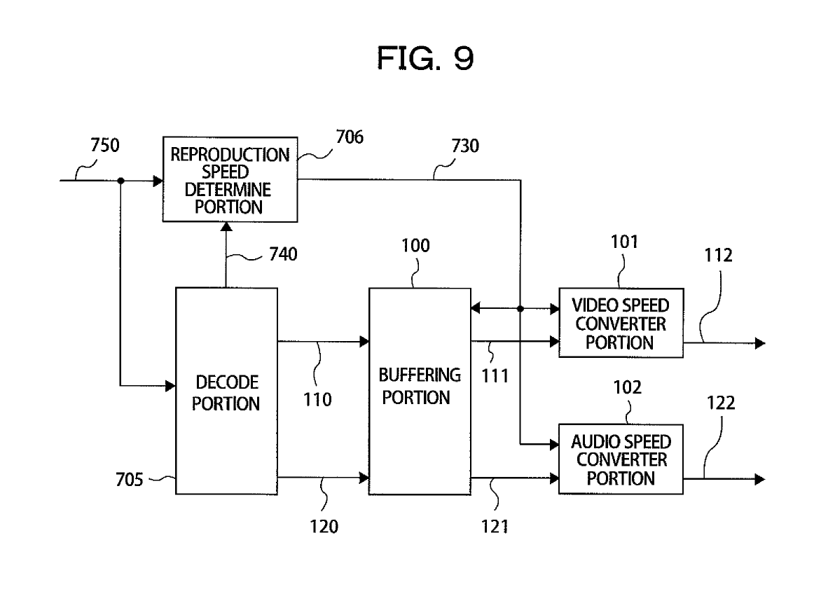

Next, explanation will be made on a fifth embodiment, by referring to FIG. 9.

This fifth embodiment has the structure of adding a reproduction speed determine portion 706 and a decode portion 705, in the place of the user interface 132, within the circuit block diagram of the first embodiment shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 9 is omitted illustration of the display portion 140 ad the speaker 150.

The decode portion 705 decodes streaming broadcast data 750, which is distributed on a network circuit, etc., and outputs the input video signal 110 and the input audio signal 120 to the buffering portion 100. It also analyzes an encode rate (distribution speed of the data, which is distributed on that streaming broadcast) from the streaming broadcast data 750, and outputs it to the reproduction speed determine portion 706 as an encode rate 740.

The reproduction speed determine portion 706 measures a speed of the network circuit, on which the streaming broadcast data 750 is transmitted. Herein, the speed of the network circuit can be measured with using any kind of methods therein; however, it is preferable of being able to detect the speed, which is as near to an effective transmission speed of the streaming broadcast data 750, as possible. For example, it is preferable to count an amount of information per a unit of time, which can be received during reception of the streaming broadcast data, to be provided as the speed of the network circuit.

Further, the speed determine portion 706 calculates out the reproduction speed, with using the following equation 1, from the measured network transmission speed of the network mentioned above, and the encode rate, which is outputted from the decode portion 705:

reproduction speed [%]=network transmission speed/encode rate×100 (Eq. 1)

In case where the calculation result of the above equation is larger than 100%, there is a surplus in the network transmission speed, and almost no waiting time is generated for buffering the stream data, therefore 100% is outputted as the control signal 730 indicating the reproduction speed of that stream data.

On the other hand, if the calculation result of the above equation is less than 100%, the waiting time mentioned above is requested before the reproduction or on the way of the reproduction, within the conventional streaming broadcast receiver. However, according to the present embodiment, the reproduction speed of that stream data is controlled, by outputting the control signal 730 applying the calculation result of the equation 1 mentioned above, as the reproduction speed of the stream data, to the video speed converter portion 101 and the audio speed converter portion 102. With this, since the reproduction speed of that stream data can be fitted with the network transmission speed, therefore it is possible to shorten, or not to generate the waiting time caused due to shortage of the network transmission speed. However, in case where the network transmission speed is too late (when it is smaller than 90% of the reproduction speed), since the wrong feeling is generated in the slow-view reproduction, the control signal 730 may be outputted, indicating a lowest reproduction speed (for example, 90%), which is determined in the place of the reproduction speed calculated from the equation 1 mentioned above, and thereby reproducing the streaming data at that lowest reproduction speed. Also, in this instance, the buffering may be conducted, in the similar manner to the conventional streaming broadcast receiver, without conducting the control of the reproduction speed (i.e., without conducting the slow-view reproduction). For example, a step may be repeated, such as, reproduction is made by conducting such a degree of the buffering that reproduction can be made, continuously, for a certain time, and reproduction is stopped, as soon as the buffer comes to be empty, and the buffering is conducted, again.

In the present embodiment, although explaining that the timing when the reproduction speed is determined by the speed determine portion 706 is arbitrary, however it may be determined when starting receipt of the streaming broadcast, for example, and may be maintained to be the same until the end of the receipt of the streaming broadcast. In this case, since the reproduction speed is always constant, such wrong feeling generated when viewing/listening can be reduced or lightened, even in the case of the slow-view reproduction (i.e., the reproduction speed 740 is less than 100%). It is also possible to continue renewal of the reproduction speed, every time when receiving the streaming broadcast. In this instance, if there is an increasing/decreasing of the network transmission speed a little bit, since the reproduction speed is adjusted to fit with it, a possibility is lessened, i.e., the waiting time is required.

With the structures mentioned above, since the speed determine portion 706 determines the reproduction speed 730 upon basis of the network transmission speed of the network and the encode rate 740 of the stream data on the stream broadcast, it is possible to reproduce the video and the audio, smoothly without a break, even if the network transmission speed is slow.

Also, the speed determine portion 706 compares the reproduction speed obtained from the equation 1 mentioned above and the lowest reproduction speed, which is determined in advance, and if the reproduction speed is lower than that, it carries out the reproduction at that lowest reproduction speed, for example, then it is possible to reproduce the video and the audio, with reducing the wrong feeling, even when the network transmission speed is too slow.

### Embodiment 6

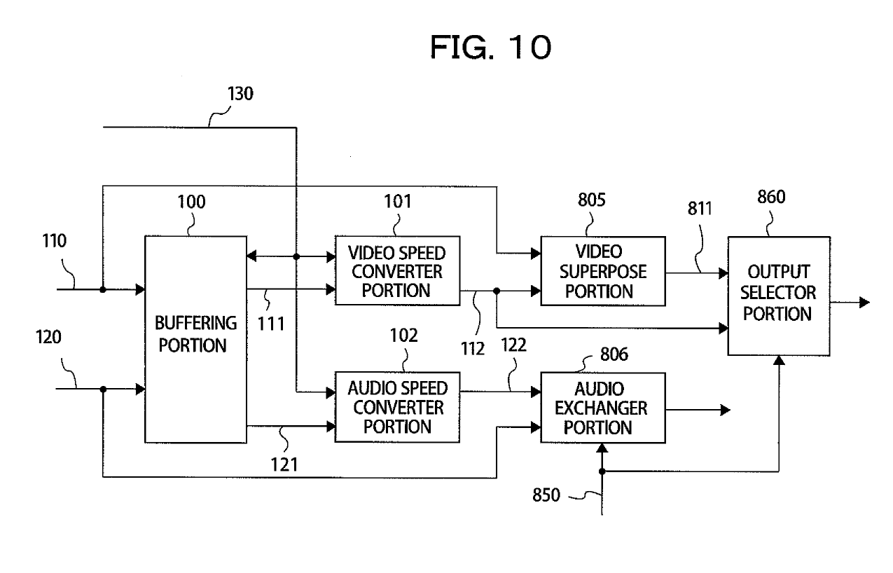

Next, explanation will be made on a sixth embodiment, by referring to FIG. 10.

This sixth embodiment has the structure of adding a video superpose portion 805, an audio exchange portion 806 and an output selector portion 860, within the circuit block diagram of the first embodiment shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 10 is omitted illustration of the display portion 140 ad the speaker 150.

The video superpose portion 805 receives the input video signal 110 and the video signal 112, the speed of which is converted within the video speed converter portion 101, and reduces that input video signal 110, or the input video signal 110 and the video speed converter portion 101, through a scaling process; thereby, outputting a video signal 811 superposing the input video signal 110 and the speed-converted video 112 thereon. This superposed video signal 813 and the speed-converted video 112 from the video speed converter portion 101 are inputted into the output selector portion 860, and the output selector portion 860 outputs either one of the superposed video signal 811 and the speed-converted video signal to the display portion 140, responding to the selector signal 850.

When the output selector portion 860 selects the superposed video signal 811, on the display portion 140 is displayed, though not shown in the figure, so-called a PinP screen, i.e., displaying a picture of the speed-converted video signal 112 as a parent picture (main picture) and a picture of the input video signal 110 as a child picture (sub-picture), for example. In the place of this PinP screen, there may be displayed, so-called a parallel 2-screen picture, i.e., displaying a picture of the speed-converted video signal and a picture of the input video signal 110 aligning left and right. With the present embodiment, since it is enough that the picture of the speed-converted video signal 112 and the picture of the input video signal can be viewed at the same time, therefore a manner of superposing both pictures may be in any kind thereof.

On the other hand, the audio exchanger portion 806 is inputted with the input audio signal and the audio signal, the speed of which is converted within the audio speed converter portion 102, and outputs either one of the audio signals to the speaker, responding to the selector signal 850.

The selector signal 850, for instructing the selection operation of the signal within the output selector portion 860 and the audio exchanger portion 806, is assumed to be produced in accordance with an instruction of the user, for example. In case when the user wishes to view a program on the air at present, during when viewing the speed-converted video, for example, the user operates a “2-screen display” button of a remote controller, for example. Responding to this operation, the selector signal 850 is produced, and the output selector portion 860 selects the superposed video signal 813 responding to the selector signal 850. In cooperation with this, the audio exchanger portion 806 operates to select the input audio signal 120 responding to the selector signal 850. Selection of this audio may be interlocked with the selection of the video, or may be conducted independent from the selection of the video signal, responding to the instruction of the user, for example.

As was mentioned above, with the present embodiment, since the video superpose portion 805 and the audio exchanger portion 806 provide an output with superposing the video, the speed of which is not converted, on the video, the speed of which is converted, therefore for the user, it is possible to confirm the program on the air at present, for example, while viewing/listening the video and the audio, the speeds of which are converted. In particular, it is possible to confirm the information having a sense of being viewed live, such as, a news flash and/or an urgent broadcast, etc., for example, while viewing/listening the video and the audio, the speeds of which are converted.

Also, when the user wishes to listen to the audio of the news flash or the urgent broadcast, etc., which is displayed on the picture superposed, it is possible to change from the audio, the speed of which is converted, into the input audio having the normal speed.

### Embodiment 7

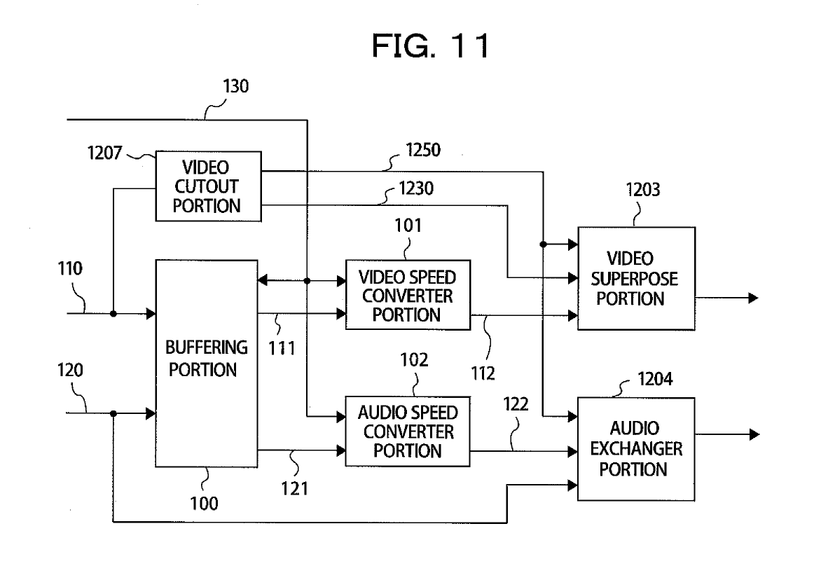

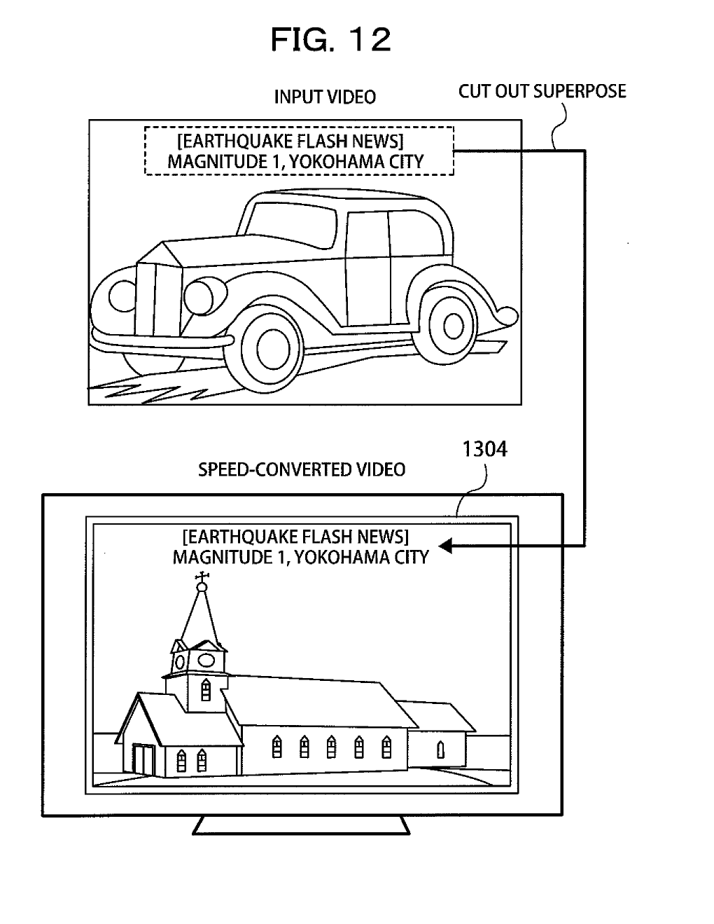

Next, explanation will be made on a seventh embodiment, by referring to FIGS. 11 and 12.

This seventh embodiment has the structure of adding a video cutout portion 1207, a video superpose portion 1203 and an audio exchanger portion 1204, within the circuit block diagram of the first embodiment shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 11 is omitted illustration of the display portion 140 ad the speaker 150.

The video cutout portion 1207 cuts out a certain specific portion of the input video signal 110, so as to output it to the video superpose portion 1203 as a cutout video signal 1230, as well as, outputs a selector signal 1250 to the video superpose portion 1203 and the audio exchanger portion 1204.

Herein, the specific portion of the input video signal 110, which is cut out within the video cutout portion 1207, includes an upper-end portion or a lower-end portion, or a left-end portion or a right-end portion of the video, for example, and in particular, it is the portion where a caption region of the news flash or the urgent broadcast appears. The caption has, in general, the characteristics; i.e., being white in the color of high brightness, and the step-wise difference in the brightness thereof is large comparing to the other video portions. For this reason, the video cutout portion 1207, according to the present embodiment, while watching the video contents at upper-end portion and the lower-end portion, or at the left-end portion and the right-end portion of the input video signal 110, detects that signal, when a signal appears at that portion, which has brightness higher than a predetermined value and the step-wise difference of brightness (i.e., an edge component) larger than a predetermined value, for a time period of ten to several tens frames, for example, as the signal of the caption. And, it cuts out a region including that caption signal detected, and outputs it to the video superpose portion 1203 as the cutout video signal 1230. Further, the video cutout portion 1207 allows superposing of this cutout video signal 1230 and the input video signal 110, and also outputs the selector signal 1250 to the video superpose portion 1203 and the audio exchanger portion 1204. If no caption region is detected, it does not transmit the selector signal 1250, or transmits the selector signal 1250 for not allowing the superposition mentioned above. Also, the video cutout portion 1207 may cut out an hour caption.

The video superpose portion 1203 superposes the cutout video signal 1230 onto the speed-converted video signal 112, when a permission signal is sent thereto, as the selector signal 1250, and outputs it to the display portion 140. When no selector signal is transmitted, or when a non-permission signal is transmitted as the selector signal 1250, it outputs the speed-converted video signal 112 to the display portion 140, as it is.

Also, the audio exchanger portion 1204 selects the input audio signal 120 when the permission signal is sent thereto as the selector signal 1250, or selects the speed-converted audio signal 122 when no selector signal is transmitted or when the non-permission is sent thereto as the selector signal 1250, and thereby outputting it to the speaker 150.

Herein, an example of display of the input video including the caption and the superposed signal, which can be obtained by the video superpose portion 1203, is shown in FIG. 12. As is shown in an upper portion of FIG. 12, when a caption 1302 appears in an upper end portion of the input video, for example, the video cutout portion 1203 obtains a display picture, as is shown in a lower portion of FIG. 12, i.e., by superposing the caption 1302 on the speed-converted video 1304. Herein, the coordinates on the screen where the caption 1302 is superposed may be arbitrary, but as is shown in the lower portion of FIG. 12, the wrong feeling can be reduced if it is superposed at the coordinates same to those of the input video, as is shown in the lower portion of FIG. 12.

Within the present embodiment, detection and cutout of the caption region can be achieved with using various kinds of methods other than those mentioned above. For example, in an upper region of an input video 1210 where the caption of the news flash or the urgent broadcast can be considered to easily appear at the most, if a long region having clear outlines can be detected, on a several or more number of frames, at the same coordinates, then it can be considered to be that caption. Also, with the hour caption, in the upper-left or the upper-right region of the input video 1210, if a region having clear outlines can be detected, on a several or more number of frames, at the same coordinates, then it can be considered to be the hour caption.

As was mentioned above, in the present embodiment, the video cutout portion 1207 cuts out a certain portion from the input video, and the video superpose portion 1203 superposes that cut-out video onto the speed-converted video signal 112; therefore, for the user, it is possible to confirm an important portion of the information having a sense of being viewed live, while viewing/listening to the speed-converted video and audio on a full screen.

In particular, in the case of the structure, in which that video cutout portion 1207 cuts out the caption region of the news flash or the urgent broadcast, since that caption region cut out is superposed on the speed-converted video signal 112, therefore, for the user, it is possible to confirm the caption of the news flash, etc., live while viewing/listening to the speed-converted video and audio. Thus, according to the present embodiment, it is possible to provide that caption, automatically, even during the time when the user is viewing/listening to the video and audio, if the news flash or the urgent broadcast is broadcasted. Also, since the audio exchange portion changes the audio into the input audio, automatically, when the caption of the news flash, etc., flows, therefore, the user can be prevented from loosing to listen to the audio of the news flash, etc.

Also, in the case where the video cutout portion 1207 has the structures of cutting out the hour caption, since that hour caption region, which is cut out, is superposed onto the speed-converted video signal 112, then the user can confirm the correct hour during when she/he is viewing/listening to the speed-converted video and audio.

### Embodiment 8

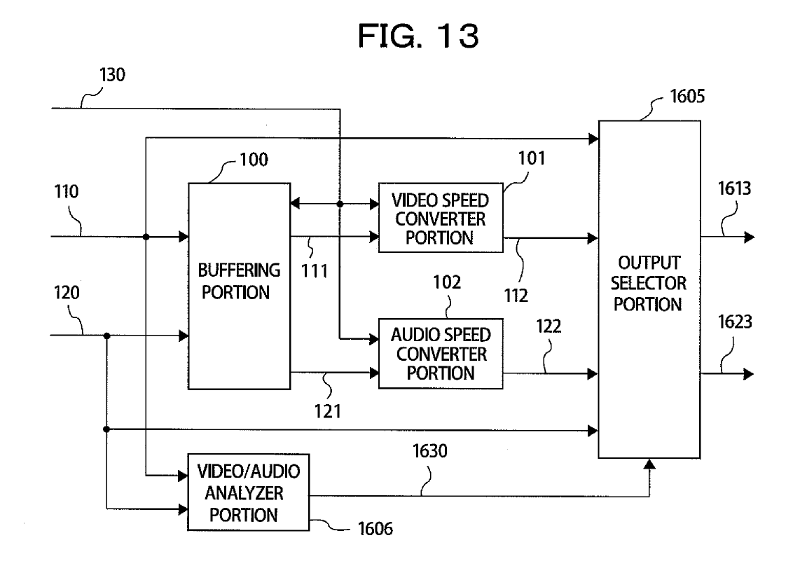

Next, explanation will be made on an eighth embodiment according to the present invention, by referring to FIG. 13.

This embodiment 8 has the structures of adding an output selector portion 1605 and a video/audio analyzer portion 1606, within the circuit block diagram of the embodiment 1 shown in FIG. 1. Within the present embodiment, the elements having functions and/or operations, being same to those of the elements, which are already explained in the embodiment 1, are attached with the same reference numerals, and duplication of the explanations thereof will be omitted, herein. However, in this FIG. 12 is omitted illustration of the display portion 140 ad the speaker 150.

The video/audio analyzer portion 1606 detects an appearance of the caption of the news flash or the urgent broadcast from the input video signal 110, with the manner same to that of the video cutout portion 1207, which was explained in the embodiment 7 mentioned above, and outputs an output selector signal 1630. Also, it may detect a start of the broadcast, such as, the news flash or the urgent broadcast, from the input audio signal 120.

To the output selector portion 1605 are inputted the input video signal 110 and the speed-converted video signal 112 from the video speed converter portion, and further the input audio signal 120 and the speed-converted audio signal 122 from the audio speed converter portion. And, the output selector portion 1605 selects the input video signal 110 and the input audio signal 120, when receiving the output selector signal 1630 from the video/audio analyzer portion 1606, i.e., the video/audio analyzer portion 1606 detects the appearance of the caption of the news flash or the urgent broadcast on the input video, and outputs them therefrom. When receiving no such output selector signal 1630, i.e., when the video/audio analyzer portion 1606 does not detects the caption mentioned above from the input video, the output selector portion 1605 selects the speed-converted input video signal 112 and output audio signal 122 therefrom.

As was mentioned above, within the present embodiment, since it is possible to exchange into that news flash or the urgent broadcast, automatically, by means of the output selector signal 1630, so as to output the video and audio thereof, when the news flash or the urgent broadcast is broadcasted during the time when the user views/listens to the selects the speed-converted input video signal 112 and the speed-converted audio signal 122, therefore the user can be prevented from loosing to see the information having a sense of being viewed live, even if she/he is viewing the video and audio, the speeds of which are converted.

### Embodiment 9

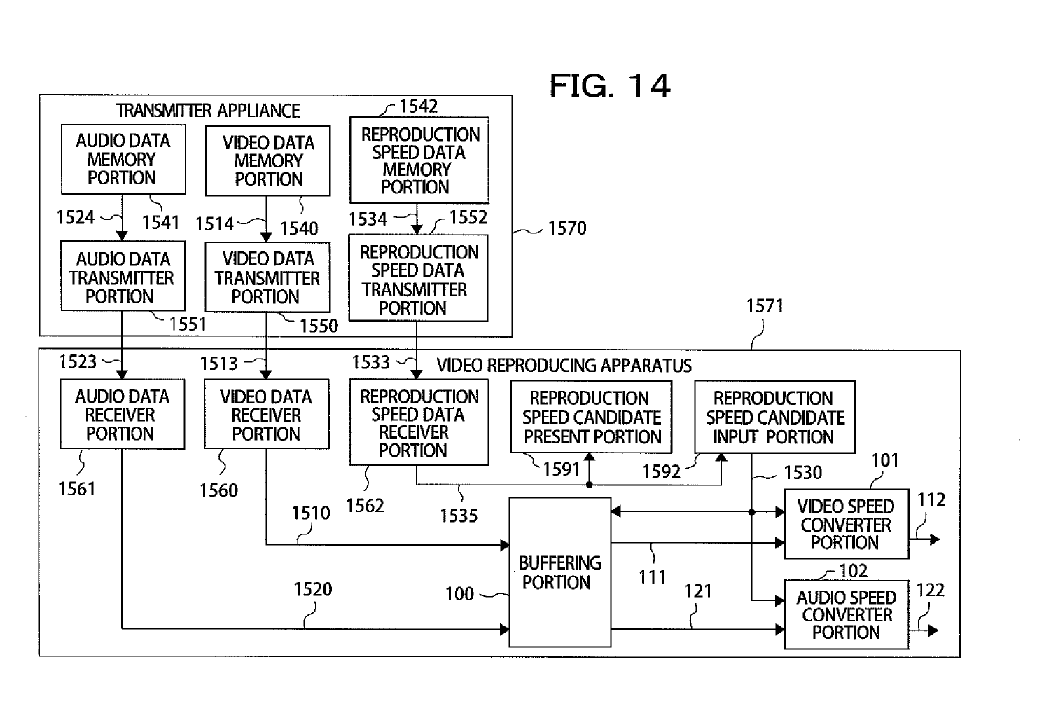

Next, explanation will be made on a ninth embodiment according to the present invention, by referring to FIG. 14.

A special reproducing apparatus of the present embodiment is constructed with a transmitter appliance 1570 and a video reproducing apparatus 1571. Within the present embodiment, the elements having functions and/or operations, being same to those of the elements, which are already explained in the embodiment 1, are attached with the same reference numerals, and duplication of the explanations thereof will be omitted, herein. However, in this FIG. 12 is omitted illustration of the display portion 140 ad the speaker 150.

The transmitter appliance 1570 comprises a video data memory portion 1540, an audio data memory portion 1541, a reproduction speed memory portion 1542, a video data transmitter portion 1550, an audio data transmitter portion 1551 and a reproduction speed transmitter portion 1552. The transmitter appliance 1570 is an appliance for transmitting the video and audio, and it is assumed that it is installed in a broadcast station.

The video reproducing apparatus 1571 further comprises the buffering portion 100 and the video speed converter portion 101 and the audio speed converter portion 102, which are explained in the embodiment 1, and it also comprises a video data receiver portion 1560, au audio data receiver portion 1562, a reproduction speed candidate present portion 1591 and a reproduction speed candidate input portion 1592. The video producing apparatus 1571 is an appliance for receiving the video and audio, and it is, for example, a television receiver, a DVD recorder, or a HDD recorder, etc., which can be used by the user.

The video data and the audio data of the program, which is received at the broadcast station, are stored in the video data memory portion 1540 and the audio data memory portion 1541, for each program. In the reproduction speed data memory portion 1542 is stored reproduction speed data, indicating with how much degree of the speed that video is allowed to reproduce, for each program. Thus, a video producer and/or a broadcast station is/are able to instruct at which of the speed the viewer is allowed to view the program.

That speed information data includes a plural number of reproduction speeds, such as, (100%, 90%, 110%), for example. In this instance, It is indicated, in this instance, that program is allowed to produce at a normal speed, and at the speed of 90% and 110% of the normal speed. Also, when it is (100%), the video and the audio are allowed to produce at the normal speed, and not allowed to produce at the speed converted.

The video data transmitter portion 1550 transmits the video data 1524, which is stored within the vide data memory portion 1540, the audio data transmitter portion 1551 transmits the audio data 1514, which is stored within the audio data memory, portion 1541, and the reproduction speed data transmitter portion 1552 transmits the reproduction speed data 1534, which is stored within the reproduction speed data memory portion 1542, to the video reproducing apparatus 1571, respectively, through an arbitrary communication means.

In the video reproducing apparatus 1571, the video data receiver portion 1560, the audio data receiver portion 1561 and the reproduction speed receiver portion 1562 receive the video data 1523, the audio data 1513 and the reproduction speed data 1533, respectively, which are transferred through the arbitrary communication means from an outside of the video reproducing apparatus 1571, and they send the video data 1523 and the audio data 1513 to the buffering portion 100. The reproduction speed data 1535, being received by the reproduction speed receiver portion 1562, is transmitted to the reproduction speed candidate present portion 1591 and the reproduction speed candidate input portion.

When she/he is trying to view a certain program, the reproduction speed candidate present portion 1591 presents the speed information, which is included in the reproduction speed data 1535 corresponding to that program, to that user of the video reproducing apparatus 1571, responding to a program selecting operation made by her/him. For example, on a screen of the display portion 140 is displayed (90%, 100%, 110%) as the candidates of the reproduction speed, upon basis of the speed information included in the reproduction speed data 1535, and thereby informing the user, at which speed that program is allowed to reproduce. Further, a plural number of the reproduction speed candidates are displayed thereon, so that any one of them can be selected by the user.

The reproduction speed input portion 1592, upon receipt of an instruction made by the user, i.e., a select instruction of the reproduction speed on the display of the reproduction speed candidates, sends it to the buffering portion 100, the video speed converter portion 101 and the audio speed converter portion 102, as a reproduction speed data selector signal 1530. The instruction of the reproduction speed (i.e. selection of the reproduction speed) from the user may be accepted through ten-keys of a remote controller, for example, if it is attached to the video reproducing apparatus 1571.

In this manner, the user of the video reproducing apparatus 1571 knows at which speed the program, which she/he wishes to view, is allowed to produce, through the reproduction speed candidate present portion 1591, and she/he can select an arbitrary one from among the speeds presented, through the reproduction speed input portion 1592.

The buffering portion 100, the video speed converter portion 101 and the audio speed 102, which are provided with the video reproducing apparatus, carry out the speed conversion, respectively, depending on the reproduction speed, which is indicated by the reproduction speed data selector signal 1530 corresponding to the control signal 130, in the similar manner to the first embodiment (FIG. 1) mentioned above, and thereby output the speed-converted video signal 112 and the speed-converted audio signal 122, which are converted into the arbitrary speeds, smoothly and naturally, respectively, to the display portion 140 and the speaker 150, which are not shown in the figure herein.

As was mentioned above, according to the present embodiment, since the transmitter appliance 1570 can transmit the reproduction speed corresponding to an intention of the video producer or the broadcast station (for example, the normal speed for music, the normal or slow speed for the CM portion, and a double-speed for the news, etc.), and since the viewer determines the reproduction speed upon basis of the reproduction speed transmitted, therefore it is possible to view the program at the reproduction speed fit to that. It is also possible to prevent the reproduction speed from being changed by the viewer, thoughtlessly.

Also, since the video reproducing apparatus 1571 determines the reproduction speed upon basis of the reproduction speed 1533, which is transmitted from the transmitter appliance 1570, it is possible for the viewer to view the program at the reproduction speed fitting to that. It is also possible to prevent the reproduction speed from being changed by the viewer, thoughtlessly, and to reproduce the program in accordance with the intention of the intention of the video producer or the broadcast station.

With the embodiments 1 to 9 according to the present invention, which are mentioned above, it is needless to say that any one of those can be implemented by itself or may be combined with other (s), arbitrarily. For example, as the control signal 130 of the embodiments 7 and 8, it is possible to apply the control signal 230 upon basis of edition of the video, which was explained in the embodiment 2, or the control signal 430 upon basis of an epg data, which was explained in the embodiment 3. Thus, the present invention should not be limited to those, but various kinds of combinations are possible.

The present invention can be applied into the video reproducing apparatus having the special functions, i.e., the quick-view reproduction of reproducing the video and audio faster than the normal reproduction speed, and the slow-view reproduction of reproducing the video and audio slower than the normal reproduction speed, and in particular, it is suitable for reducing the wrong feeling of the video and audio, which are obtained through those special reproduction.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. A video reproducing apparatus, for outputting an input video signal while holding it temporarily therein, comprising:
a buffering portion; and
a video speed converter portion, which is configured to produce an interpolation frame responding to motion of video with using a plural number of video frames, which are outputted from said buffering portion, and thereby outputting a video signal, a reproduction speed of which is converted by combining said interpolation frame and the video frame from said buffering portion, wherein
a control signal for designating the reproduction speed to the buffering portion and said video speed converter portion is inputted therein, and
a time distance of the video frames of the video signal, which is outputted from said buffering portion, and a process of said producing process of said interpolation frame and said combining process within said video speed converter portion are controlled depending upon said control signal.

2. The video reproducing apparatus, as described in the claim 1, further comprising:
an audio speed converter portion, which is configured to convert a reproduction speed of an input audio signal depending on said control signal, wherein
said audio speed converter portion carries out conversion of the reproduction speed of said audio signal by divides the audio, timewisely, as well as, copying or deleting said time-wisely divided audio signal, periodically, at a timing depending on the reproduction speed, at which said control signal indicates.

3. The video reproducing apparatus, as described in the claim 1, further comprising:
an user interface portion, which is configured to set up the reproduction speed through an instruction by a user, and to produce said control signal upon basis of said setup reproduction speed, thereby to output it.

4. The video reproducing apparatus, as described in the claim 2, further comprising:
a video/audio editor portion, which is configured to delete or add video and audio, wherein
said control signal is produced upon basis of the reproduction speed depending on time when the video and audio are deleted or added by said video/audio editor portion.

5. The video reproducing apparatus, as described in the claim 4, wherein
said video/audio editor portion includes a discriminate portion, which is configured to discriminate a commercial portion from the video and audio, wherein
said video/audio editor portion determines the reproduction speed upon basis of the time of said deleted commercial portion, when the commercial portion, which is discriminated by said discriminate portion, is edited to be deleted by said video/audio editor portion, thereby to output said control signal therefrom, and
by said buffering portion, said video speed converter portion and said audio speed converter portion, in accordance with said control signal, video deleting the commercial portion thereof from said input video signal and said input audio signal is reproduced, slower than said input video signal and said input audio signal.

6. The video reproducing apparatus, as described in the claim 1, further comprising:
a program listing data obtain portion, which is configured to obtain information relating to a program listing; and
a program listing data analyzer portion, which is configured to analyzes said program listing data, which is obtained by within said program listing data obtain portion, and to determine the reproduction speed depending on contents of a program, thereby outputting said control signal.

7. The video reproducing apparatus, as described in the claim 1, further comprising:
a selector portion, which is configured to exchange the plural number of input videos and the input audios, and to output said control signal upon basis of the reproduction speed depending on said exchanging.

8. The video reproducing apparatus, as described in the claim 1, further comprising:
a decode portion, which is configured to decode an input stream, and to output the input video signal, the input audio signal and an encode rate; and
a reproduction speed determine portion, which is configured to detect a speed of a network, on which said input video signal and said input audio signal are communicated, and to determine the reproduction speed upon basis of said network transmission speed and said encode rate, which is outputted from said decode portion, thereby outputting said control signal.

9. The video reproducing apparatus, as described in the claim 8, wherein
said reproduction speed determine portion compares said network transmission speed and a predetermined lowest reproduction speed, and outputs a control signal to set said lowest reproduction speed to be the reproduction speed when said network transmission speed is slower than said lowest reproduction speed.

10. The video reproducing apparatus, as described in the claim 1, further comprising:
a video superpose portion, which is configured to superpose said input video on the video signal, the reproduction speed of which is converted by said video speed converter portion; and
an audio exchanger portion, which is configured to exchange either the audio signal, the reproduction speed of which is converted by said audio speed converter portion, or said input audio signal, thereby to output it therefrom, wherein
while the video, the reproduction speed of which is converted, and the video, the reproduction speed of which is not converted, are outputted, simultaneously, by said video superpose portion, either the audio, said reproduction speed of which is converted, or the audio, said reproduction speed of which is not converted, can be outputted, by said audio exchanger portion.

11. The video reproducing apparatus, as described in the claim 10, further comprising:
a video cutout portion, which is configured to cut out a partial region of said input video signal, thereby to transmit it to said video superpose portion, wherein
the video, said reproduction speed of which is converted, can be displayed, with superposing a portion of the video, which is cut out by said video cutout portion, and said reproduction speed of which is not converted, thereon.

12. The video reproducing apparatus, as described in the claim 11, wherein
said video cutout portion is so configured to detect a caption region from the input video signal, and it cuts out outputs said caption and outputs it to said video superpose portion, when detecting said caption, and it further output a selector signal to said video superpose portion and said audio exchanger portion, and
when said video cutout portion detects said caption, said video superpose portion outputs the video signal, on which the caption outputted from said video cutout portion, and the reproduction speed of which is converted, responding to said selector signal, and said audio exchanger portion selects the input audio signal, said reproduction speed of which is not converted, thereby to output it, responding to said selector signal.

13. The video reproducing apparatus, as described in the claim 1, further comprising:
an output selector portion, which is configured to select and output either the video signal, the reproduction of which is converted by said video speed converter portion, or the input video signal, said reproduction speed of which is not converted, as well as, to select and output either the audio signal, the reproduction speed of which is converted by said audio speed converter portion, or the input audio signal, said reproduction speed of which is not converted.

14. The video reproducing apparatus, as described in the claim 13, further comprising:
a video/audio analyzer portion, which is configured to detect the video signal or the audio signal of specific contents, from said input video signal and said input audio signal, thereby to output the selector signal to said output selector portion, wherein
said output selector portion selects said input video signal and said input audio signal responding to said selector signal, when said video/audio analyzer portion detects the video signal or the audio signal of said specific contents, and thereby outputting them therefrom.

15. The video reproducing apparatus, as described in the claim 14, wherein
the video signal or the audio signal of said specific contents is a caption relating to a news flash and/or an urgent broadcast, and
when the news flash and/or the urgent broadcast are/is broadcasted during time when the user views the video and the audio, the reproduction speeds of which are converted, then the caption or the audio signal relating to said news flash and/or said urgent broadcast is detected by said video/audio analyzer portion, and an exchange is made by said output selector portion, from the video and the audio, the reproduction speeds of which are converted, into said input video signal and said input audio signal.

16. A video system, comprising:
a transmitter appliance, which is configured to transmit a video signal and an audio signal; and
a video reproducing apparatus, which is configured to receive and reproduce the video signal and the audio signal from said transmitter appliance, wherein
said transmitter appliance includes a reproduction speed data transmitter portion, which is configured to transmit said video signal and audio signal, and further data relating to reproduction speeds of said video signal and audio signal,
said video reproducing apparatus includes:
a reproduction speed data receiver portion, which is configured to obtain said reproduction speed data from said transmitter appliance; and
a speed converter portion, which is configured to convert the reproduction speeds of the video signal and the audio signal, which are transmitted from said transmitter appliance, in accordance with said reproduction speed data received from said reproduction speed data receiver portion, and thereby outputting them therefrom.

17. The video system, as described in the claim 16, wherein
said speed converter portion, which is configured to hold therein the video signal from said transmitter appliance, temporarily, and comprises:
a buffering portion; and
a video speed converter portion, which is configured to produce an interpolation frame responding to motion of video with using a plural number of video frames, which are outputted from said buffering portion, and thereby outputting a video signal, a reproduction speed of which is converted by combining said interpolation frame and the video frame from said buffering portion, wherein
a control signal for designating the reproduction speed to the buffering portion and said video speed converter portion is inputted therein, and
a time distance of the video frames of the video signal, which is outputted from said buffering portion, and a process of said producing process of said interpolation frame and said combining process within said video speed converter portion are controlled depending upon said control signal.

18. A method for converting a reproduction speed of video, comprising the following steps of:
controlling a time distance between video frames in a video signal inputted, depending on a reproduction speed designated;
detecting a motion vector of the video, with using a plural number of video frames, which are controlled on said time distance thereof, and producing an interpolation frame; and
converting the reproduction speed of said input video signal by combining the video frames, said time distance of which is controlled, and said interpolation frame.
